(19) United States
(12) Patent Application Publication
(10) Pub. No.: US 2014/0064433 A1
(43) Pub. Date: Mar. 6, 2014

(54) Fuel Assembly and Core of Nuclear Reactor

(71) Applicant: Hitachi-GE Nuclear Energy, Ltd., Hitachi-shi (JP)

(72) Inventors: Naoyuki Nakadozono, Tokyo (JP); Takeshi Mitsuyasu, Tokyo (JP); Tomohiko Ikegawa, Tokyo (JP)

(73) Assignee: Hitachi-GE Nuclear Energy, Ltd., Hitachi-shi (JP)

(21) Appl. No.: 14/013,095

(22) Filed: Aug. 29, 2013

(30) Foreign Application Priority Data
Aug. 31, 2012 (JP) 2012-191257

(51) Int. Cl. G21C 3/328

(52) U.S. Cl. CPC G21C 3/328
USPC 376/435

(57) ABSTRACT

In a fuel assembly having fuel rods U1 to U4, and P1 not containing gadolinia, and fuel rods G1-G3 containing gadolinia, the concentrations a of gadolinia in nuclear fuel materials A (8 wt % and 10 wt %) satisfy 0.7<a/aₘₐₓ≦1.0, the concentrations b of gadolinia in nuclear fuel materials B (5 wt % and 6 wt %) satisfy 0.4<b/aₘₐₓ≦0.7, the concentration c of gadolinia in a nuclear fuel material C (2 wt %) satisfies 0<c/aₘₐₓ≦0.4, and L(A)/5.0≧L(B) and L(B)/5.0≧L(C) are satisfied. The gadolinia with concentrations a burns out during the end of cycle, the gadolinia with concentrations b during the middle of cycle, and the gadolinia with a concentration c during the beginning of cycle. L(A) is the total axial length of zones filled with the nuclear fuel materials A in the fuel rods G1-G3, L(B) for materials B in G2 and G3, and L(C) material C in G1.

### CLAIM OF PRIORITY

The present application claims priority from Japanese Patent application serial no. 2012-191257, filed on Aug. 31, 2012, the content of which is hereby incorporated by reference into this application.

### BACKGROUND OF THE INVENTION

1. Technical Field

The present invention relates to a fuel assembly and a core of a nuclear reactor and, in particular, to a fuel assembly and a core of a nuclear reactor suitable for applying to a boiling water nuclear power plant.

2. Background Art

A plurality of fuel assemblies are loaded into a core in a reactor pressure vessel of a boiling water nuclear power plant. The fuel assembly has a plurality of fuel rods in which a plurality of fuel pellets containing nuclear fuel materials (for example, uranium dioxide) are disposed, a lower tie plate for supporting a lower end portion of each fuel rod, an upper tie plate for supporting a upper end portion of each fuel rod, a plurality of fuel spacers disposed in the axial direction for maintaining space among the fuel rods, and a tubular channel box having a square cross-section. The channel box is attached to the upper tie plate at an upper end portion of the channel box and extends toward the lower tie plate to surround the plurality of fuel rods bundled by the plurality of fuel spacers.

A plurality of control rods are disposed in the reactor pressure vessel, which is inserted into or withdrawn from the core to control reactor power. Some of the fuel rods in the fuel assembly contain burnable poison (for example, gadolinia) in the fuel pellets. The control rods and the burnable poison absorb neutrons excessively generated by the nuclear fission of nuclear fuel materials. The burnable poison which absorbed neutrons is converted into a material with less neutron absorbency. Thus, after fresh fuel assemblies with a burnup of 0 GWd/t is loaded into the core and after a certain period of time has passed since start of operation of the boiling water nuclear power plant, the burnable poison contained in the fresh fuel assemblies is converted into a material with less neutron absorbency and disappears. The fuel assemblies without the burnable poison have monotonously decreasing reactivity as its nuclear fuel material burns.

Since the core is loaded with a plurality of fuel assemblies having different in-core fuel dwelling times, the reactivity of the core as a whole is maintained in an approximately flat state throughout operation cycles. Surplus reactivity (excess reactivity) at rated thermal power operation of the core is controlled by the number of control rods inserted into the core, the depth of the insertion of the control rods into the core, and a core flow rate. In addition, the excess reactivity is flattened to some extent by the concentrations of burnable poison in the fuel assemblies and the arrangement of fuel rods containing the burnable poison. Excess reactivity which could not be flattened by burnable poison is managed by changing a pattern of control rods.

The duration of neutron absorbing effect of the burnable poison can be adjusted by changing the concentrations of burnable poison, and reactivity during beginning of the operation cycle can be adjusted by changing the number of the fuel rods containing burnable poison. The concentrations of burnable poison in the fuel assembly, the arrangement of the burnable poison in the axial direction and in a cross-section of the fuel assembly, and the number of burnable poison-contained fuel rods can be adjusted to adjust the reactivity of the core and to control excess reactivity. Furthermore, adjusting these can improve core performance such as thermal margin and economical efficiency of fuel.

In the fuel assembly described in Japanese Patent Laid-open No. 3 (1991)-267793 (see FIGS. 1 and 2), average concentration of burnable poison in a lower region in the axial direction of the fuel assembly is made larger than average concentration of burnable poison in an upper region, and the concentration of burnable poison in the lower region of one or two burnable poison-contained fuel rods among the fuel rods containing burnable poison, provided to the fuel assembly, is made smaller than the concentration of that in the upper region. In a boiling water reactor in general, since neutron moderation effect is greater in the lower region of the core having a lower void fraction (a volume ratio of steam to the gas-liquid two-phase flow including steam and water) than the upper region of the core, the reactivity of the lower region of the core is increased. Consequently, the power in the lower region of the core becomes higher than that of the upper region of the core. In Japanese Patent Laid-open No. 3 (1991)-267793, more burnable poison is disposed in the lower region of the core to reduce a power peak in the lower region of the core during the beginning of the operation cycle, and thus, the maximum linear heat generation rate, which is a fuel operating limit, can be kept within its design criterion.

Furthermore, since the concentration of burnable poison in the lower region of one or two fuel rods among the burnable poison-contained fuel rods is made lower than the average content of burnable poison in the upper region, the power in the lower region of the core is increased after this burnable poison burns out, that is, after the beginning of the operation cycle; this makes power distribution in an axial direction of the core have a peak in the lower portion. When the power distribution in the axial direction of the core has a peak in the lower portion during the beginning and the middle of the operation cycle and the average void fraction in the core is increased, the neutron spectrum is hardened and plutonium, which is a nuclear fuel material, can be accumulated. Consequently, the reactivity is increased. During the end of the operation cycle, the power distribution in the axial direction of the core has a peak in the upper portion because the burnable poison burns out and the nuclear fuel material in the lower region of the core is further burned during the beginning and the middle of the operation cycle, decreasing the amount of the nuclear fuel material in the region. Because of this, the average void fraction in the core is reduced, the neutron spectrum is softened, and the reactivity can be increased. Therefore, the nuclear fuel material can burn efficiently, so the economical efficiency of fuel is improved.

Japanese Patent Laid-open No. 2 (1990)-245693 describes a fuel assembly which can reduce axial power peaking during the beginning of cycle and can suppress a change in the power peaking. A fuel assembly 20 shown in FIGS. 15 and 16 has 15 burnable poison-contained fuel rods; in 8 first burnable poison-contained fuel rods among the 15 burnable poison-contained fuel rods, the concentrations of burnable poison in the lower regions are higher than the average concentration of burnable poison in the upper regions of all the burnable poison-contained fuel rods, and in 4 second burnable poison-contained fuel rods, the concentrations of burnable poison in the lower regions (gadolinia concentration: 2.0 wt %) are lower than the average concentration of burnable poison in the upper regions described above.

The fuel assembly 20 adds the burnable poison with a low concentration to lower regions of second burnable poison-contained fuel rods in a fuel assembly 21 shown in FIG. 17, the fuel assembly 21 including first burnable poison-contained fuel rods containing burnable poison in the lower region having a higher concentration than the average concentration of the burnable poison in the upper region, and the second burnable poison-contained fuel rods containing burnable poison in the lower region having a concentration of 0 wt % and burnable poison in the upper region having the average concentration. Because of this, the fuel assembly 20 achieves infinite neutron multiplication factor which increases almost linearly with respect to the burnup during the beginning of the operation cycle (see FIG. 19). In the fuel assembly 20, after the low-concentrated (2.0 wt %) burnable poison in the lower regions of the second burnable poison-contained fuel rods has been burned out, the number of the burnable poison-contained fuel rods in the lower region of the fuel assembly 20 becomes less than the number of that in the upper region.

### CITATION LIST

### Patent Literature

[Patent Literature 1] Japanese Patent Laid-open No. 3 (1991)-267793
[Patent Literature 2] Japanese Patent Laid-open No. 2 (1990)-245693

### SUMMARY OF THE INVENTION

### Technical Problem

Generally, when the variation range of excess reactivity is large, the pattern of withdrawing control rods needs to be changed often to control reactivity, which complicates the operation of boiling water nuclear power plant. As described above, fuel assemblies with a burnup of 0 GWd/t contain burnable poison. The burnable poison burns during an operation cycle and thus, the reactivity changes greatly.

The inventors studied a change in the reactivity during the first operation cycle in each core separately loaded the fuel assemblies shown in FIGS. 1 and 2 of Japanese Patent Laid-open No. 3 (1991)-267793 and the fuel assemblies shown in FIGS. 15 and 16 of Japanese Patent Laid-open No. 2 (1990)-245693 all with a burnup of 0 GWd/t. As a result, the inventors newly found out that these fuel assemblies loaded into the core at a burnup of 0 GWd/t have the reactivity which has a downwardly convex change as the burnup increases during the middle of the operation cycle. The fuel assemblies described in Japanese Patent Laid-open No. 3 (1991)-267793 and Japanese Patent Laid-open No. 2 (1990)-245693 which include the fuel rods having low-concentrated burnable poison in the lower regions can improve a downwardly convex change in the reactivity which occurs as the burnup increases during the beginning of the operation cycle. However, the downwardly convex change in the reactivity which occurs during the middle of the operation cycle cannot be improved. This increases the variation range of excess reactivity during the operation cycle.

It is an object of the present invention to provide a fuel assembly and a core of a nuclear reactor which can further reduce variation range of excess reactivity of the core during an operation cycle.

### Solution to Problem

A feature of the present invention for achieving the above object is a fuel assembly comprising a plurality of fuel rods; an upper tie plate for supporting an upper end portion of each of the fuel rods; a lower tie plate for supporting a lower end portion of each of the fuel rods; a plurality of fuel spacers for maintaining space among the fuel rods; and a channel box for surrounding the plurality of fuel rods bundled by the fuel spacers,

wherein the plurality of fuel rods include a plurality of first fuel rods filled with nuclear fuel material not containing burnable poison and a plurality of second fuel rods filled with nuclear fuel material containing burnable poison;

wherein number of the second fuel rods is at least 8% of a total number of the first and the second fuel rods;

wherein when the highest concentration among the concentrations of the burnable poison contained in the nuclear fuel material filled in the plurality of second fuel rods is aₘₐₓ; a concentration a of the burnable poison contained in the nuclear fuel material is in a range of 0.7<a/aₘₐₓ≦1.0; a concentration b of the burnable poison contained in the nuclear fuel material is in a range of 0.4<b/aₘₐₓ≦0.7; and a concentration c of the burnable poison contained in the nuclear fuel material is in a range of 0<c/aₘₐₓ≦0.4, a nuclear fuel material B, which is a nuclear fuel material containing the burnable poison with the concentration b, and a nuclear fuel material C, which is a nuclear fuel material containing the burnable poison with the concentration c, are disposed between a position up to 1/24 of a total axial length in an axial direction of an active fuel length of the fuel assembly from a lower end of the active fuel length and a position up to 19/24 of the total length in the axial direction of the active fuel length from the lower end of the active fuel length; and

wherein a total length L(A) in the axial direction of zones filled with nuclear fuel materials A, which are nuclear fuel materials containing the burnable poison with the concentration a, in all the second fuel rods, a total length L(B) in the axial direction of zones filled with the nuclear fuel materials B in all the second fuel rods, and a total length L(C) in the axial direction of zones filled with the nuclear fuel materials C in all the second fuel rods satisfy L(A)/5.0≧L(B) and L(B)/5.0≧L(C).

According to the present invention, since the concentration a of the burnable poison contained in the nuclear fuel material A satisfies 0.7<a/aₘₐₓ≦1.0; the concentration b of the burnable poison contained in the nuclear fuel material B satisfies 0.4<b/aₘₐₓ≦0.7; the concentration c of the burnable poison contained in the nuclear fuel material C satisfies 0<c/aₘₐₓ≦0.4; and L(A)/5.0≧L(B) and L(B)/5.0≧L(C) are also satisfied, a downwardly convex change in reactivity during the middle of an operation cycle of a first operation cycle, which is an initial operation cycle for the fuel assemblies with a burnup of 0 GWd/t, caused by the nuclear fuel material A containing the burnable poison with the concentration a, can be compensated by effect of the burnable poison with the concentration b contained in the nuclear fuel material B, which burns out during the middle of the operation cycle. In addition, a downwardly convex change in the reactivity during the beginning of the operation cycle of the first operation cycle, which is the initial operation cycle for the fuel assemblies with a burnup of 0 GWd/t, caused by the nuclear fuel material B containing the burnable poison with the concentration b can be compensated by the effect of the burnable poison with the concentration c contained in the nuclear fuel material C, which burns out in the beginning of the operation cycle. Thus, the downwardly convex changes in the reactivity during the middle and the beginning of the operation cycle can be improved and the variation range of the excess reactivity of the core during the operation cycle can be reduced.

The above object can also be achieved by a core of a nuclear reactor loaded with a plurality of fuel assemblies including a plurality of first fuel rods filled with nuclear fuel material not containing burnable poison and a plurality of second fuel rods filled with nuclear fuel material containing the burnable poison,

wherein a plurality of the fuel assemblies with a burnup of 0 GWd/t which is part of all the fuel assemblies loaded in the core have the second fuel rods, the number of which is at least 8% of a total number of the first and the second fuel rods;

wherein in the plurality of the fuel assemblies with a burnup of 0 GWd/t, when a highest concentration among the concentrations of the burnable poison contained in the nuclear fuel materials filled in the plurality of second fuel rods is aₘₐₓ; a concentration a of the burnable poison contained in the nuclear fuel material is in the range of 0.7<a/aₘₐₓ≦1.0; a concentration b of the burnable poison contained in the nuclear fuel material is in the range of 0.4<b/aₘₐₓ≦0.7; and a concentration c of the burnable poison contained in the nuclear fuel material is in the range of 0<c/aₘₐₓ≦0.4, a nuclear fuel material B, which is a nuclear fuel material containing the burnable poison with the concentration b, and a nuclear fuel material C, which is a nuclear fuel material containing the burnable poison with the concentration c, are disposed between a position up to 1/24 of a total length in an axial direction of an active fuel length of the fuel assembly from a lower end of the active fuel length and a position up to 19/24 of the total length in the axial direction of the active fuel length from the lower end of the active fuel length; and

wherein in the plurality of the fuel assemblies with a burnup of 0 GWd/t, when a total length in the axial direction of zones filled with nuclear fuel materials A, which are nuclear fuel materials containing the burnable poison with the concentration a, in all the second fuel rods is L(A), a total length in the axial direction of zones filled with the nuclear fuel materials B in all the second fuel rods is L(B), and a total length in the axial direction of zones filled with the nuclear fuel materials C in all the second fuel rods is L(C), L(A)/5.0≧L(B) and L(B)/5.0≧L(C) are satisfied.

### Advantageous Effect of the Invention

According to the present invention, the variation range of the excess reactivity of the core during an operation cycle can be further reduced.

### BRIEF DESCRIPTION OF THE DRAWINGS

FIG. 1 is a cross-sectional view showing a part of a core of a nuclear reactor in which fuel assemblies according to embodiment 1, which is a preferred embodiment of the present invention, were loaded.

FIG. 2 is an explanatory drawing showing distribution of concentration of burnable poison (for example, gadolinia) and enrichment of each fuel rod disposed in a fuel assembly shown in FIG. 1.

FIG. 3 is a longitudinal sectional view showing a fuel assembly shown in FIG. 1.

FIG. 4 is a characteristic drawing showing a change in reactivity of each of fuel assembly containing gadolinia and fuel assembly not containing gadolinia as a function of burnup.

FIG. 5 is a characteristic drawing showing a relationship between gadolinia concentration and average enrichment of a fuel assembly to batch number for a core.

FIG. 6 is a characteristic drawing showing distribution of burnup in an axial direction of a fuel assembly shown in FIG. 1 at completion of an operation cycle.

FIG. 7 is a characteristic drawing showing a change in reactivity of a fuel assembly, as a function of burnup, at a cross-section of a zone having a nuclear fuel material A containing gadolinia with a concentration which allows the gadolinia to burn out during end of an operation cycle.

FIG. 8 is a characteristic drawing showing a change in excess reactivity during an operation cycle as a function of cycle burnup.

FIG. 9 is a characteristic drawing showing a change in reactivity of a fuel assembly, as a function of burnup, at a cross-section of a zone having a nuclear fuel material A containing gadolinia with a concentration which allows the gadolinia to burn out during end of an operation cycle and a change in reactivity of the fuel assembly, as a function of burnup, at a cross-section of a zone having a nuclear fuel material B containing gadolinia with a concentration which allows the gadolinia to burn out during middle of the operation cycle.

FIG. 10 is a characteristic drawing showing a change in reactivity, as a function of burnup, obtained by weighted averaging, at a ratio of 5:1, the reactivity of a fuel assembly at a cross-section of a zone having a nuclear fuel material A containing gadolinia with a concentration which allows the gadolinia to burn out during end of an operation cycle and reactivity of the fuel assembly at a cross-section of a zone having a nuclear fuel material B containing gadolinia with a concentration which allows the gadolinia to burn out during middle of the operation cycle.

FIG. 11 is a characteristic drawing showing a change in a maximum distance, as a function of L(B)/L(A), between a first approximate line and a curve showing a change in reactivity obtained by weighted averaging first and second reactivities during a first operation cycle.

FIG. 12 is a characteristic drawing showing a change in reactivity of a fuel assembly, as a function of burnup, at a cross-section of a zone having a nuclear fuel material B containing gadolinia with a concentration which allows the gadolinia to burn out during middle of an operation cycle and a change in reactivity of the fuel assembly, as a function of burnup, at a cross-section of a zone having a nuclear fuel material C containing gadolinia with a concentration which allows the gadolinia to burn out during beginning of the operation cycle.

FIG. 13 is a characteristic drawing showing a change in reactivity, as a function of burnup, at a cross-section of each of a plurality of fuel assemblies having different numbers of gadolinia-contained fuel rods.

FIG. 14 is a characteristic drawing showing a relationship between a ratio of the number of gadolinia-contained fuel rods to the number of all fuel rods included in a fuel assembly and reactivity of the fuel assembly at a burnup of 0 GWd/t.

FIG. 15 is a characteristic drawing showing a change in excess reactivity of a core, as a function of cycle burnup, loaded with fuel assemblies having nuclear fuel rods shown in FIG. 1.

FIG. 16 is a characteristic drawing showing a change in a maximum distance, as a function of L(C)/L(B), between a second approximate line and a curve showing a change in reactivity obtained by weighted averaging second and third reactivities during a first operation cycle.

FIG. 17 is an explanatory drawing showing distribution of concentrations of burnable poison (for example, gadolinia) and enrichment of each fuel rod disposed in a fuel assembly according to embodiment 2, which is another preferred embodiment of the present invention.

FIG. 18 is a characteristic drawing showing a change in excess reactivity of a core, as a function of cycle burnup, loaded with fuel assemblies having fuel rods shown in FIG. 17.

### DETAILED DESCRIPTION OF THE PREFERRED EMBODIMENTS

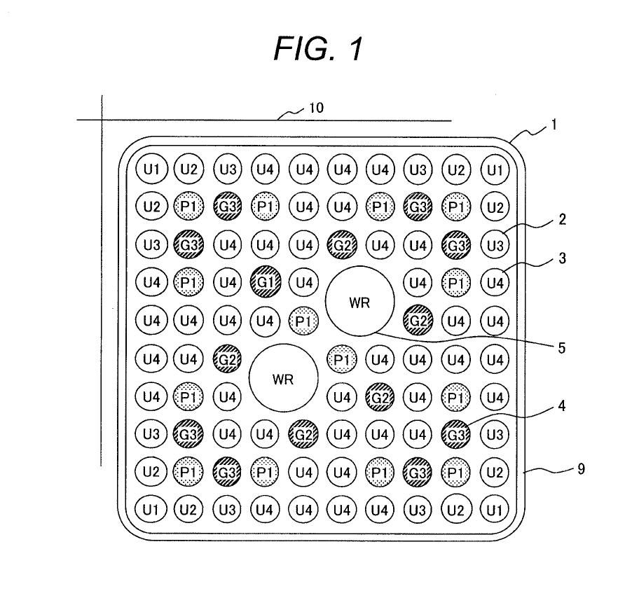

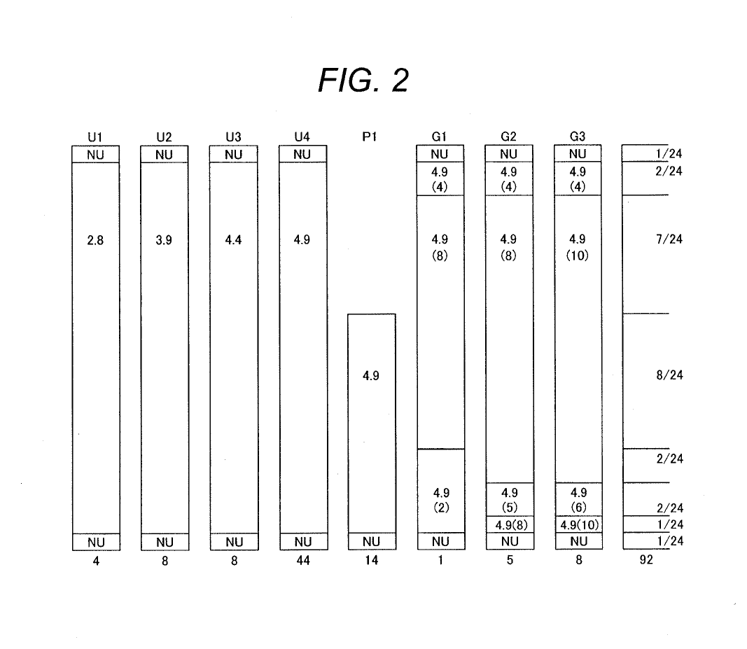

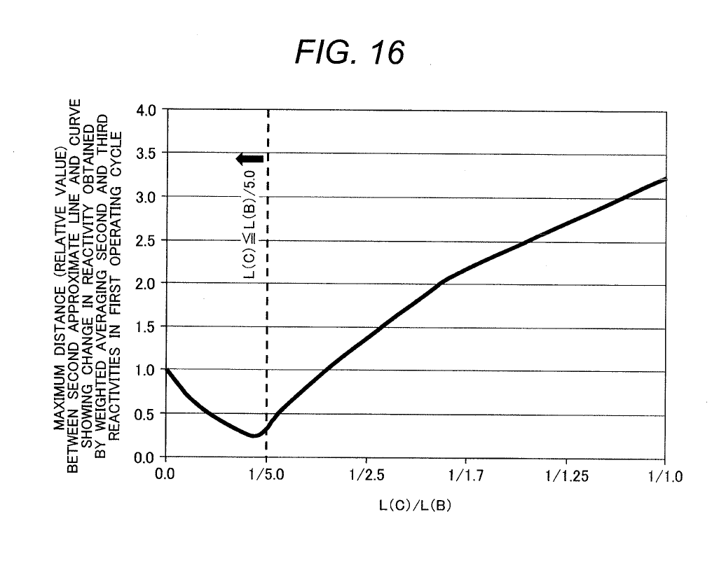

As described above, the inventors studied a change in reactivity during the first operation cycle after the fuel assemblies shown in FIGS. 1 and 2 of Japanese Patent Laid-open No. 3 (1991)-267793 and the fuel assemblies shown in FIGS. 15 and 16 of Japanese Patent Laid-open No. 2 (1990)-245693 all with a burnup of 0 GWd/t are separately loaded into a core. As a result, the inventors found out a new issue that the excess reactivity during the operation cycle cannot be flattened because the reactivity of these fuel assemblies loaded into the core at a burnup of 0 GWd/t has an downwardly convex change as the burnup increases during the middle of the operation cycle.

In order to solve this problem, the inventors performed various studies. The contents of these studies will be described below.

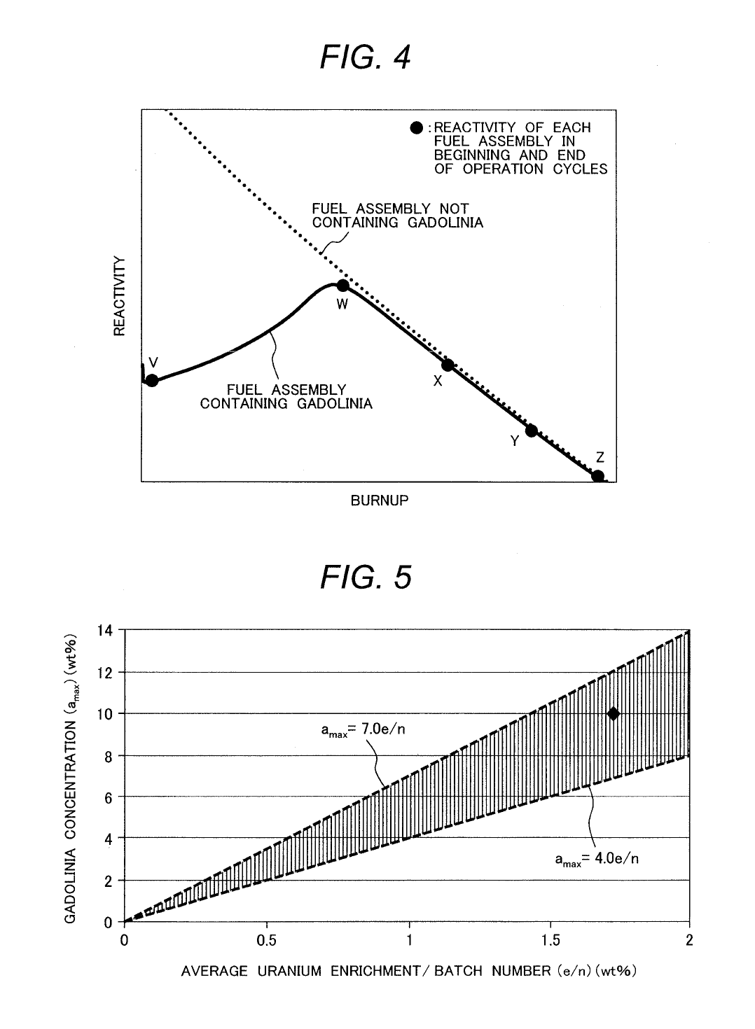

First of all, a general effect of gadolinia as burnable poison will be explained. A fuel assembly with a burnup of 0 GWd/t (hereinafter referred to as a fresh fuel assembly) contains gadolinia as burnable poison to reduce reactivity. FIG. 4 shows a change in the reactivity, as a function of burnup, at a cross-section of the fresh fuel assembly from the time of its loading into the core until the time of its removal from the core. FIG. 4 also shows as a reference, in a dotted line, a change in the reactivity, as a function of burnup, at a cross-section of a fuel assembly not containing gadolinia. Since the gadolinia is decreased with burning, the reactivity of the fresh fuel assembly loaded into the core increases with the burning of gadolinia.

The core has a plurality of fuel assemblies having different in-core fuel dwelling times (i.e. having different number of operation cycles experienced while dwelling in the core). As shown in FIG. 4, while the reactivity of the fresh fuel assembly is increased from the point V to the point W with burning, the reactivity of the now-partially-burned fuel assembly is decreased from the point W to the point X, the point X to the point Y, and the point Y to the point Z. Thus, in the core as a whole, the reactivity increasing from the point V to the point W of the fresh fuel assembly experiencing a first operation cycle of the reactor after being loaded into the core is offset by the reactivity decreasing from the point W to the point X and from the point X to the point Y of the fuel assemblies having different in-core fuel dwelling times experiencing the second or later operation cycle of the reactor after being loaded into the core. Consequently, as shown in FIG. 8, the excess reactivity of the core can be reduced throughout an operation cycle, making the reactivity control of the reactor easier. FIG. 8 shows a change in the excess reactivity as a function of cycle burnup. The cycle burnup means increase in the average of the burnup of the fuel assemblies loaded into the core, in a single operation cycle.

When the burnable poison contained in the fresh fuel assembly remains at completion of an initial operation cycle (hereinafter referred to as a first operation cycle) for the fresh fuel assembly, the reactivity of the core will be decreased in a next operation cycle of the reactor for this fuel assembly. Consequently, in this fuel assembly, economical efficiency of fuel reduces. Thus, the amount of burnable poison contained in the fresh fuel assembly is set so as to make all the burnable poison burn out at the completion of the first operation cycle.

The maximum concentration aₘₐₓ among the concentrations of burnable poison contained in the nuclear fuel material in the fuel assembly and the burnup of the fuel assembly at which the burnable poison burns out have an approximate linear relationship as expressed in equation (1).

αaₘₐₓ=Ec (1)

where Ec is a cycle burnup at the completion of the first operation cycle, and α is a proportionality factor. When the concentration aₘₐₓ of burnable poison is set to satisfy the equation (1), the burnable poison contained in the fresh fuel assembly can burn out at the completion of the first operation cycle.

On the other hand, the product of a cycle burnup and a batch number (a ratio of the number of fresh fuel assemblies to the number of all the fuel assemblies loaded into the core) is called discharge burnup. The discharge burnup is equal to the average burnup of spent fuel assembly taken out from the core; it is an index for representing the cumulative power of the fuel assemblies. The discharge burnup Eex is expressed in equation (2). A relationship between the cycle burnup Ec, the batch number n, and the discharge burnup Eex is expressed in the following equation.

nEc=Eex (2)

The higher the average uranium enrichment of the fuel assemblies, the more the power; consequently, the discharge burnup of the fuel assemblies becomes larger. The discharge burnup Eex can be expressed as equation (3) using the average uranium enrichment e and a proportionality factor β.

Eex=βe (3)

From the equations (1), (2), and (3), the concentration aₘₐₓ of the burnable poison which burns out at the completion of the first operation cycle, the average uranium enrichment e, and the batch number n have a relationship shown in equation (4).

aₘₐₓ=(β/α)e/n (4)

The inventors analyzed composition of a nuclear fuel material in the fuel assembly having a fuel rod array of 9 rows by 9 columns used in an advanced boiling water reactor; and consequently found out, as shown in FIG. 5, that when the condition of 4.0<aₘₐₓn/e<7.0 is satisfied, burnable poison can burn out at the completion of the first operation cycle and reactor operation with good economical efficiency of fuel can be achieved.

Next, determination of the concentrations of burnable poison and its effect which characterize the present invention will be described. When the start of the first operation cycle is 0 and the completion of the cycle is Ec, the first operation cycle is divided into three periods of 0 to 0.4Ec, 0.4Ec to 0.7Ec, and 0.7Ec to Ec. Then, the period of 0 to 0.4Ec is defined as the beginning of the operation cycle, the period of 0.4Ec to 0.7Ec as the middle of the operation cycle, and the period of 0.7 Ec to Ec as the end of the operation cycle. Furthermore, the nuclear fuel material containing the burnable poison with a concentration a which burns out during the end of the operation cycle is a nuclear fuel material A, the nuclear fuel material containing the burnable poison with a concentration b which burns out during the middle of the operation cycle is a nuclear fuel material B, the nuclear fuel material containing the burnable poison with a concentration c which burns out during the beginning of the operation cycle is a nuclear fuel material C.

The present invention is characterized in that part of the nuclear fuel material A is replaced by the nuclear fuel material B and the nuclear fuel material C.

As described above, the concentration of the burnable poison contained in the fuel assembly and the burnup at which the burnable poison burns out have an approximate liner relationship expressed in the equation (1), thus the concentration c of the burnable poison contained in the nuclear fuel material C, the concentration b of the burnable poison contained in the nuclear fuel material B, and the concentration a of the burnable poison contained in the nuclear fuel material A should satisfy 0.0<c/aₘₐₓ≦0.4, 0.4<b/aₘₐₓ≦0.7, and 0.7<a/aₘₐₓ≦1.0 with respect to the concentration aₘₐₓ of gadolinia which burns out at the completion of the first operation cycle.

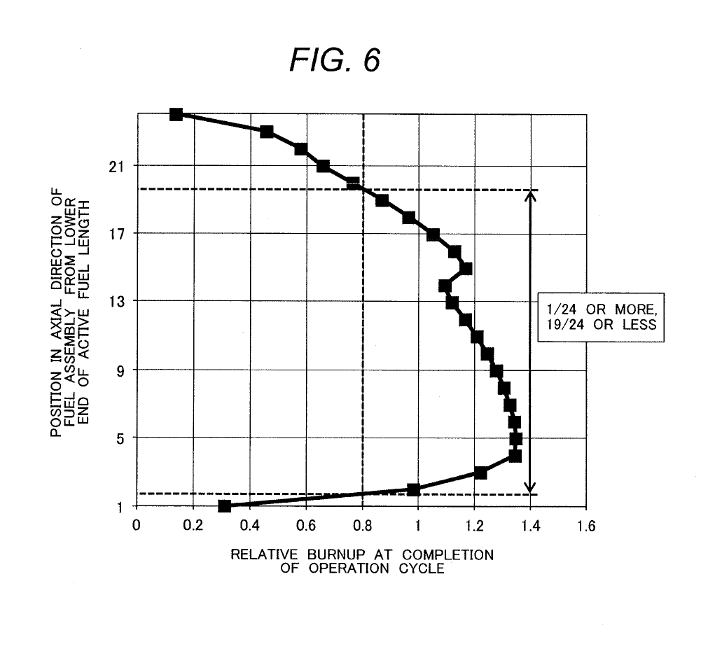

However, the burnable poison contained in each of the nuclear fuel materials B and C needs to burn out before the end of the operation cycle. Therefore, the nuclear fuel materials B and C need to be disposed in locations which allow easy burning of the burnable poison in the fuel rods included in the fuel assembly. FIG. 6 shows the distribution of burnup in an axial direction at the completion of the first operation cycle in a fuel assembly according to embodiment 1 described later. A longitudinal axis shows each zone when an active fuel length is divided into 24 sections in the axial direction, and a lateral axis shows the burnup of each zone in the axial direction normalized to make the total 24. The active fuel length means the axial length of a nuclear fuel material filling zone in the fuel assembly. Since the upper end portion of the active fuel length in the axial direction has a large void fraction, the neutron spectrum is hard and burnable poison burns slowly. Since the lower end portion of the active fuel length in the axial direction has a large neutron leakage and low power, burnable poison burns slowly. Thus, the nuclear fuel materials B and C need to be disposed in a zone between a position up to 1/24 of a total axial length of the active fuel length from a lower end of the active fuel length and a position up to 19/24 of the total axial length of the active fuel length from the lower end of the active fuel length, where burnable poison burns faster and the relative burnup is at least 0.8.

The burnable poison with a lower concentration than the concentration a of the burnable poison contained in the nuclear fuel material A (for example, 4 wt % gadolinia contained in fuel rods G1 to G3 in a fuel assembly 1 described later), the burnable poison existing above the position up to 19/24 of the total axial length from the lower end of the active fuel length, does not burn out during the beginning and the middle of the operation cycle. For this reason, the nuclear fuel material containing the burnable poison with the above concentration existing above the position up to 19/24 of the total axial length of the active fuel length from the lower end of the active fuel length is neither a nuclear fuel material B nor C. In addition, a downwardly convex change in the reactivity during the middle of the operation cycle, which is a factor to increase variation range of the excess reactivity during the operation cycle, becomes more prominent when the concentration of burnable poison is higher. Because of this, even when the burnable poison existing above the position up to 19/24 of the total axial length of the active fuel length from the lower end of the active fuel length burns out during the end of the operation cycle, this burnable poison has less contribution to the factor of increasing the variation range of the excess reactivity because its concentration is lower than the concentration a of the burnable poison contained in the nuclear fuel material A which burns out during the end of the operation cycle. Therefore, the nuclear fuel material containing the burnable poison with a lower concentration than the concentration a of the burnable poison contained in the nuclear fuel material A, existing above the position up to 19/24 of the total axial length of the active fuel length from the lower end of the active fuel length, is not a nuclear fuel material A either.

Next, the effect that is obtained by disposing, in the fuel assembly, the nuclear fuel material B containing the burnable poison with the concentration b which burns out during the middle of the operation cycle will be described.

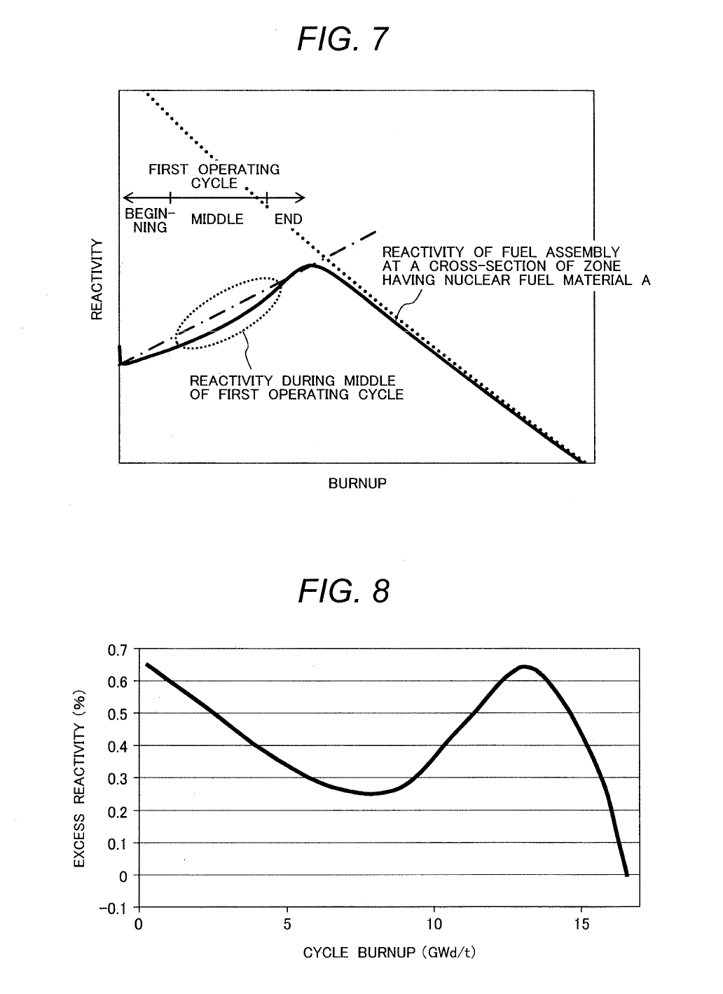

FIG. 7 shows an example of a change in the reactivity of the fuel assembly at a cross-section of a zone having the nuclear fuel material A containing the burnable poison with the concentration a which burns out during the end of the operation cycle, as a function of burnup. The reactivity of the fuel assembly at a cross-section of the zone having the nuclear fuel material A containing the burnable poison with the concentration a which burns out during the end of the operation cycle (hereinafter referred to as the first reactivity) is calculated based on the fuel assembly 1 according to embodiment 1 described later.

The reactivity at a cross-section of a zone between a position up to 6/24 of the total axial length of the active fuel length from the lower end of the active fuel length and an upper end of a partial length fuel rod P1 in the fuel assembly 1, that is, the first reactivity, was calculated for each corresponding burnup using the uranium enrichments of the fuel rods U1 to U4, P1, and G1 to G3 at the cross-section of this zone (the values shown without parenthesis for the fuel rods shown in FIG. 2, that is, 2.8 wt %, 3.9 wt %, 4.4 wt %, and 4.9 wt %) and the concentrations of gadolinia in the fuel rods G1 to G3 at the cross-section of this zone (the values shown in parenthesis for the fuel rods shown in FIG. 2, that is, 8 wt % and 10 wt %). A characteristic of a change in the first reactivity shown by a solid line in FIG. 7 can be obtained by using the first reactivity calculated for each burnup.

In FIG. 7, the period when the reactivity increases with an increase in burnup is the period when the burnable poison in the fuel assembly is absorbing neutrons, that is, the period when the burnable poison exists in the fuel assembly. The increase in the first reactivity obtained at a cross-section of the zone between the position up to 6/24 of the total axial length of the active fuel length from the lower end of the active fuel length and the upper end of the partial length fuel rod P1 of the fuel assembly 1 has a downwardly convex curve (the portion circled by a dotted line in FIG. 7) somewhat lower than the straight line indicated by a dot and dash line during the middle of the operation cycle due to a change in the neutron absorption reaction rate of the burnable poison. Because of this downwardly convex change in the first reactivity, the excess reactivity of the core shows a downwardly convex change during the middle of the operation cycle as shown in FIG. 8. As a result, the variation range of the excess reactivity is increased. This characteristic is common to fuel assemblies in general.

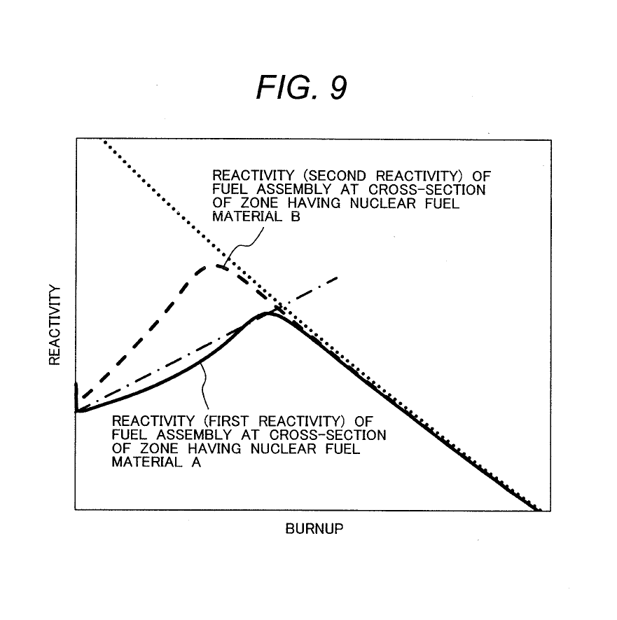

On the other hand, as shown in FIG. 9, the burnable poison contained in a zone having the nuclear fuel material B in the fuel assembly burns out during the middle of the operation cycle, thereby increasing reactivity. Therefore, by replacing part of the nuclear fuel material A with the nuclear fuel material B, the downwardly convex change in the first reactivity during the middle of the operation cycle caused by the nuclear fuel material A can be compensated. As a result, the excess reactivity of the core during the middle of the operation cycle is increased and the variation range of excess reactivity can be reduced.

FIG. 9 shows an example of a change in the reactivity of the fuel assembly, as a function of burnup, at a cross-section of a zone having the nuclear fuel material B containing the burnable poison with a concentration b which burns out during the middle of the operation cycle (hereinafter referred to as the second reactivity). The second reactivity was calculated based on a first altered fuel assembly in which 2 wt % gadolinia concentration (burnable poison concentration) in the fuel rod G1 is changed to 5 wt % in the zone between a position up to 2/24 of the total axial length of the active fuel length from the lower end of the active fuel length and a position up to 4/24 of the total axial length of the active fuel length from the lower end of the active fuel length (see FIG. 2) and further, concentrations of gadolinia in the fuel rod G1 are set to 8 wt % in a zone between the position up to 1/24 and a position up to 2/24 of the total axial length of the active fuel length from the lower end of the active fuel length and in the zone between a position up to 4/24 and a position up to 21/24 of the total axial length of the active fuel length from the lower end of the active fuel length in the fuel assembly 1 according to embodiment 1 described later. The first altered fuel assembly has the same structure as the fuel assembly 1 except that the concentration of gadolinia in the fuel rod G1 is 5 wt % in the zone between the position up to 2/24 and the position up to 4/24 of the total axial length of the active fuel length from the lower end of the active fuel length and additionally, the concentrations of gadolinia in the fuel rod G1 are 8 wt % both in the zone between the position up to 1/24 and the position up to 2/24 of the total axial length of the active fuel length from the lower end of the active fuel length and in the zone between the position up to 4/24 and the position up to 21/24 of the total axial length of the active fuel length from the lower end of the active fuel length. The distribution of uranium enrichments in the fuel rods U1 to U4, P1, and G1 to G3 and the distribution gadolinia concentrations in the fuel rods G2 and G3 included in the first altered fuel assembly are the same as the fuel assembly 1.

The reactivity of the first altered fuel assembly at a cross-section of the zone between the position up to 2/24 and the position up to 4/24 of the total axial length of the active fuel length from the lower end of the active fuel length, that is, the second reactivity of the first altered fuel assembly, was calculated for each corresponding burnup using the uranium enrichments of the fuel rods U1 to U4, P1, and G1 to G3 at the cross-section of this zone, the gadolinia concentrations in the fuel rods G2 and G3 at the cross-section of this zone, and 8 wt % of the fuel rod G1. A characteristic showing a change in the second reactivity shown in a broken line in FIG. 9 can be obtained by using the second reactivity calculated for each burnup.

As obvious from the two reactivities shown in FIG. 9, that is, the changes in the first and the second reactivities, when the average uranium enrichment is the same, the lower the concentration of the burnable poison contained in the fuel assembly with a burnup of 0 GWd/t, the larger the reactivity of when the burnable poison burns out. The second reactivity of when the burnable poison contained in the nuclear fuel material B burns out is larger than the first reactivity of when the burnable poison contained in the nuclear fuel material A burns out, whose concentration of the burnable poison is higher than the nuclear fuel material B. A degree of an increase in the reactivity when the nuclear fuel material A is replaced by the nuclear fuel material B is larger compared to a degree of a decrease in the downwardly convex change in the reactivity at a cross-section of the zone having the nuclear fuel material A in the fuel assembly during the middle of the operation cycle. Thus, in order for the nuclear fuel material B to compensate the first reactivity, which has a downwardly convex change during the middle of the operation cycle caused by the nuclear fuel material A, and to reduce the variation range of the excess reactivity of the core, L(A) and L(B) need to satisfy L(A)>L(B). Note that L(A) is a total of length in the axial direction of each zone filled with the nuclear fuel materials A in all the burnable poison-contained fuel rods in the fuel assembly, and L(B) is a total of length in the axial direction of each zone filled with the nuclear fuel materials B in all the burnable poison-contained fuel rods in the fuel assembly.

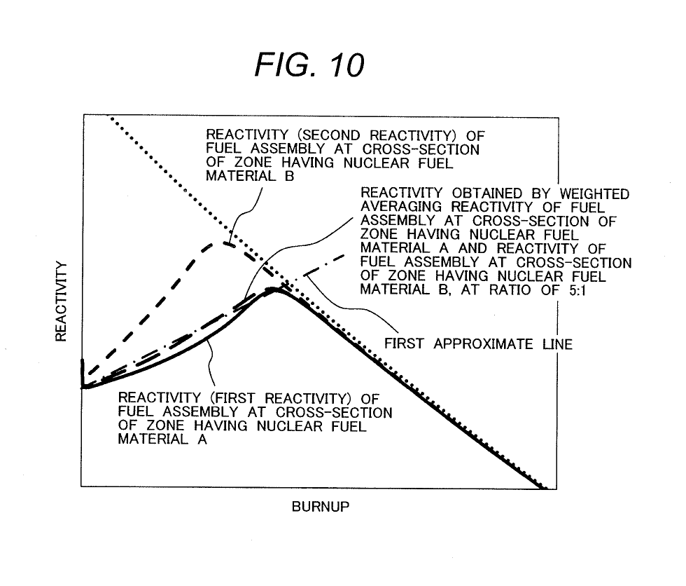

In addition, in order for the nuclear fuel material B to compensate the downwardly convex change in the first reactivity during the middle of the operation cycle due to the nuclear fuel material A, the inventors took a weighted average of the two reactivities shown in FIG. 9, that is, the reactivity (the first reactivity) at a cross-section of the zone having the nuclear fuel material A in the fuel assembly and the reactivity (the second reactivity) at a cross-section of the zone having the nuclear fuel material B in the fuel assembly. As an example, a change in the reactivity, as a function of burnup, obtained by weighted averaging the first and the second reactivities at a ratio of 5:1 is shown in FIG. 10. As obvious from the change in the reactivity (the curve shown in a broken line in FIG. 10) obtained by weighted averaging the first and the second reactivities at the ratio of 5:1, the downwardly convex change in the first reactivity during the middle of the operation cycle caused by the nuclear fuel material A is compensated by the nuclear fuel material B and changed to an approximate straight line in the middle of the operation cycle.

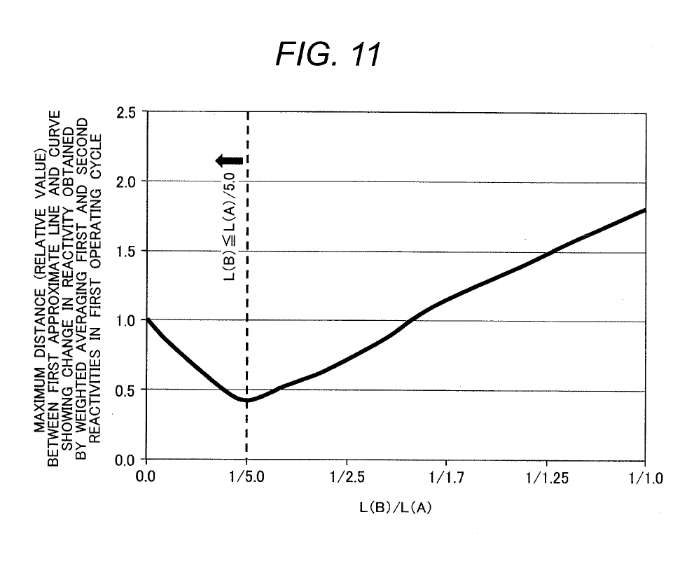

In the change in the reactivity caused by the nuclear fuel material A, a line (a straight line shown in a dot and dash line in FIG. 9) connecting a minimum value of the reactivity when the burnup is 0 GWd/t and the peak of the reactivity when the burnable poison contained in the nuclear fuel material A burns out is called a first approximate line. The inventors changed a weighted average ratio for the first and the second reactivities during the first operation cycle from 1.0 to 1.1 and obtained a maximum distance between the first approximate line and each curve (for example, the curve shown in the broken line in FIG. 10 when the weighted averaging ratio is 5:1) showing a change in the reactivity obtained by weighted averaging the first and the second reactivities using each ratio. FIG. 11 shows the maximum length obtained by using each ratio mentioned above in relation to L(B)/L(A) because the weighted average ratio for the first and the second reactivities corresponds to L(B)/L(A). Note that the maximum distance is normalized using a distance between the first approximate line and the downwardly convex reactivity curve of the first reactivity (the curve shown in a solid line in FIG. 10).

As shown in FIG. 11, the downwardly convex change in the first reactivity due to the nuclear fuel material A compensated by the nuclear fuel material B comes closest to the first approximate line when L(B)/L(A) is 1/5.0. When L(B)/L(A)>1/5.0, the effect of the second reactivity by the nuclear fuel material B becomes greater and the reactivity during the middle of the operation cycle has an upwardly convex change. Generally in the end of cycle, all burnable poison burns out and only uranium in the fuel rods keeps decreasing with burning, so that excess reactivity is reduced as shown in FIG. 8. Then, the excess reactivity reaches the minimum at the completion of the operation cycle. Normally, since the concentration and the disposal of burnable poison are designed so as to make the burnable poison burn out before the completion of operation cycle, the reactivity at the completion of operation cycle is determined only by the average uranium enrichment and not dependent on the value of L(B)/L(A). On the other hand, as described above, when L(B)/L(A)>1/5.0, the reactivity during the middle of the operation cycle has an upwardly convex change, so that the excess reactivity also has an upwardly convex change. Therefore, the maximum value of the excess reactivity in the region of L(B)/L(A)>1/5.0 becomes larger, and thus, the variation range of the excess reactivity during the middle of the operation cycle is increased. From above, a reduction in the variation range of excess reactivity can be achieved when L(A)/5.0≧L(B), which is when the reactivity changes in the form of a downward convexity or a straight line in the middle of the operation cycle.

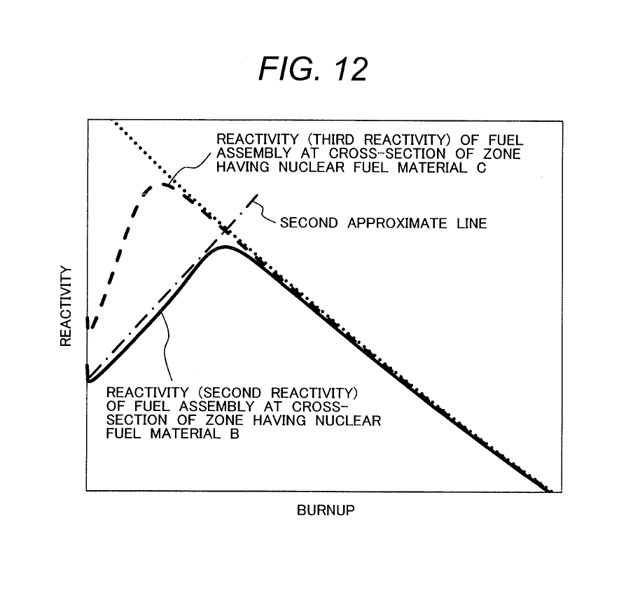

The effect obtained by disposing, in the fuel assembly, the nuclear fuel material C containing the burnable poison with a concentration c which burns out during the beginning of the operation cycle will be described. A broken line in FIG. 12 shows an example of a change in the reactivity of the fuel assembly, as a function of burnup, of the zone having the nuclear fuel material C (hereinafter referred to as the third reactivity). While the nuclear fuel material B filled in the fuel rods of the fuel assembly is used to compensate the downwardly convex change in the first reactivity caused by the nuclear fuel material A, the nuclear fuel material C compensates a downwardly convex change in the second reactivity caused by the nuclear fuel material B (see FIG. 12). From this, the variation range of excess reactivity during the beginning of the operation cycle can be reduced. Note that a total length L(C), which is the total axial length of zones filled with the nuclear fuel materials C in all the burnable poison-contained fuel rods in the fuel assembly, needs to satisfy L(B)>L(C).

The third reactivity was calculated based on a second altered fuel assembly in which gadolinia concentrations (burnable poison concentrations) of 8 wt % and 10 wt % in the fuel rods G2 and G3 are each changed to 2 wt % in the zone between the position up to 4/24 of the total axial length of the active fuel length from the lower end of the active fuel length and the upper end of the partial length fuel rod P1 in the fuel assembly 1 according to embodiment 1 described later (see FIG. 2). The second altered fuel assembly has the same structure as the fuel assembly 1 except that the gadolinia concentration is 2 wt % in the zone between the position up to 4/24 of the total axial length of the active fuel length from the lower end of the active fuel length and the upper end of the partial length fuel rod P1, in the fuel rods G2 and G3. In the second altered fuel assembly, the distribution of uranium enrichments in the fuel rods U1 to U4, P1, and G1 to G3, the distribution of gadolinia concentrations in the fuel rod G1, and the distribution of gadolinia concentrations in the zone between the position up to 1/24 and the position up to 4/24 of the total axial length of the active fuel length from the lower end of the active fuel length and in the zone between the upper end of the partial length fuel rod P1 and a position up to 23/24 of the total axial length of the active fuel length from the lower end of the active fuel length in the fuel rods G2 and G3 are the same as those of the fuel assembly 1.

The reactivity at a cross-section of the zone between the position up to 4/24 of the total axial length of the active fuel length from the lower end of the active fuel length and the upper end of the partial length fuel rod P1 of the second altered fuel assembly, that is, the third reactivity, was calculated for each corresponding burnup using the uranium enrichments of the fuel rods U1 to U4, P1, and G1 to G3 at the cross-section of this zone, the gadolinia concentration in the fuel rod G1 at the cross-section of this zone, and 2 wt % in each of the fuel rods G2 and G3. A characteristic showing a change in the third reactivity shown in a broken line in FIG. 12 can be obtained by using the third reactivity calculated for each burnup.

In the change in the reactivity caused by the nuclear fuel material B, a line (a straight line shown in a dot and dash line in FIG. 12) connecting a minimum value of the reactivity when the burnup is 0 GWd/t and a peak of the reactivity when the burnable poison contained in the nuclear fuel material B burns out is called a second approximate line of reactivity. The inventors changed the weighted average ratio for the second and the third reactivities during the first operation cycle from 0:1 to 1:1 and obtained the maximum distance between the second approximate line and each curve showing a change in the reactivity obtained by weighted averaging the second and the third reactivities using each ratio. FIG. 16 shows the maximum distance obtained by using each ratio mentioned above in relation to L(C)/L(B) because the weighted average ratio for the second and the third reactivities corresponds to L(C)/L(B). The maximum distance is normalized using a distance between the second approximate line and the downwardly convex reactivity curve of the second reactivity.

In the same manner as the relationship between L(A) and L(B) described using FIG. 11, the effect of the third reactivity by the nuclear fuel material C becomes greater when L(C)/L(B)>1/5.0 as shown in FIG. 16. This causes the reactivity during the beginning of the operation cycle to have an upwardly convex change, so that the excess reactivity also has an upwardly convex change. Therefore, the maximum value of the excess reactivity in a region of L(C)/L(B)>1/5.0 becomes larger, so that the variation range of the excess reactivity during the operation cycle also becomes larger. From above, a reduction in the variation range of the excess reactivity can be achieved when L(B)/5.0≧L(C), which is when the reactivity changes in the form of a downward convexity or a straight line in the beginning of the operation cycle.

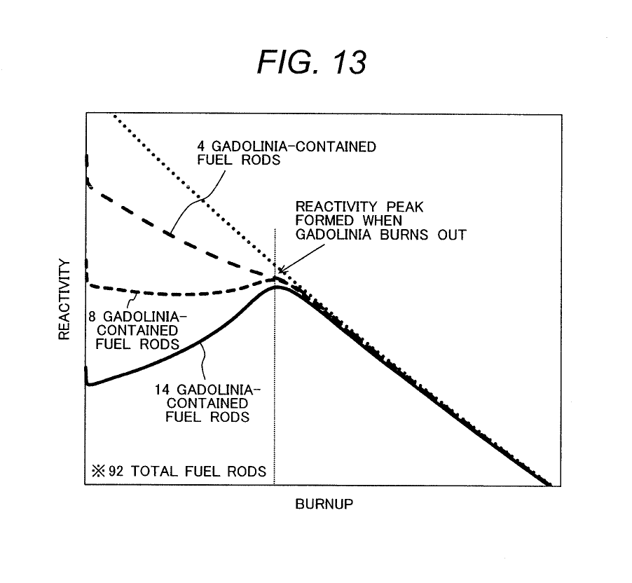

A difference in the reactivity change due to a difference in a ratio of the number of burnable poison-contained fuel rods to the number of all the fuel rods including partial length fuel rods in the fuel assembly will be described with reference to FIG. 13. As the fuel assembly 1 according to embodiment 1 described later, when 14 burnable poison-contained fuel rods are included in the total of 92 fuel rods, the reactivity at a burnup of 0 GWd/t can be sufficiently reduced, and the value of which is lower than a reactivity peak formed when gadolinia burns out during the end of the operation cycle. Thus, the reactivity increases as the gadolinia disappears during the period of gadolinia existence in the fuel assembly. When 8 of the 92 total fuel rods are burnable poison-contained fuel rods, the reactivity at a burnup of 0 GWd/t is approximately the same as the reactivity of when gadolinia burns out during the end of the operation cycle. Thus, the reactivity change is nearly flat in the period of gadolinia existence. When 4 of the 92 total fuel rods are burnable poison-contained fuel rods, the reactivity at a burnup of 0 GWd/t is not sufficiently reduced, and the value of which is higher than the reactivity of when gadolinia burns out during the end of the operation cycle. Thus, the reactivity decreases during the period of gadolinia existence. When the ratio of the number of burnable poison-contained fuel rods to the number of all the fuel rods in the fuel assembly is small and the change in the reactivity during the period of burnable poison existence in the fuel assembly is flat or decreasing, the excess reactivity in the core cannot be reduced. For this reason, the ratio of the number of burnable poison-contained fuel rods to the number of all the fuel rods in the fuel assembly needs to be set so as to make the reactivity at a burnup of 0 GWd/t be lower than the reactivity peak formed when all the burnable poison disappears during the end of the operation cycle and to make the reactivity increase as the burnable poison disappears.

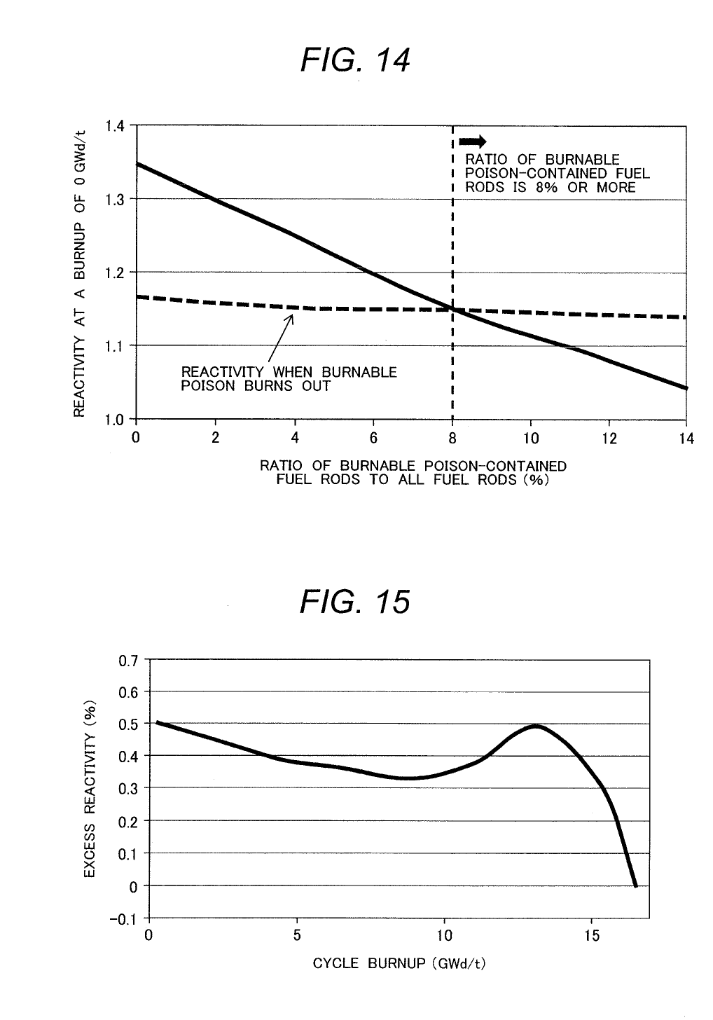

Determination of the ratio of the number of burnable poison-contained fuel rods to the number of all the fuel rods in the fuel assembly will be described. A relationship between the reactivity at a burnup of 0 GWd/t and the ratio of the number of burnable poison-contained fuel rods to the number of all the fuel rods disposed in the fuel assembly is shown in FIG. 14. When the reactivity at a burnup of 0 GWd/t is smaller compared to the reactivity of when the burnable poison burns out during the end of the operation cycle, the reactivity increases as the burnable poison disappears; thus, the ratio of the number of burnable poison-contained fuel rods to the number of all the fuel rods disposed in the fuel assembly should be at least 8% based on the characteristic shown in FIG. 14. The upper limit of the ratio of the number of burnable poison-contained fuel rods to the number of all the fuel rods in the fuel assembly is determined to be in a range in which the fuel assembly can fulfill its function of maintaining the reactivity of the core at criticality even in the beginning of burning. When gadolinia is used as burnable poison, the upper limit is 30%; and when erbia is used, the upper limit is 100%.

In the fuel assembly 1 according to embodiment 1 described later, while the number of all the fuel rods is 92, the number of burnable poison-contained fuel rods is 14. Thus, the ratio of the number of burnable poison-contained fuel rods to the number of all the fuel rods is 15%, which exceeds the lower limit of 8%.

In the fuel assembly including the nuclear fuel materials C and B in addition to the nuclear fuel material A, the burnable poison contained in the nuclear fuel material C burns out during the beginning of the operation cycle and the burnable poison contained in the nuclear fuel material B burns out during the middle of the operation cycle, so that the variation range of the excess reactivity of the core loaded with the fuel assemblies can be reduced to smaller than the variation range of the excess reactivity of the core shown in FIG. 8. The variation range of the excess reactivity, in the first operation cycle, of the core loaded with the fuel assemblies (the fuel assemblies 1 according to embodiment 1 described later, as an example) is small as shown in FIG. 15. This variation range of excess reactivity is 0.50%, which is less than 0.65%, the variation range of excess reactivity shown in FIG. 8.

Embodiments of the present invention reflecting the above study results will be described below.

### Embodiment 1

A fuel assembly according to embodiment 1, which is a preferred embodiment of the present invention, will be described with reference to FIGS. 1, 2, and 3. Fuel assemblies 1 with a burnup of 0 GWd/t according to the present embodiment are loaded into a core of a boiling water nuclear reactor.

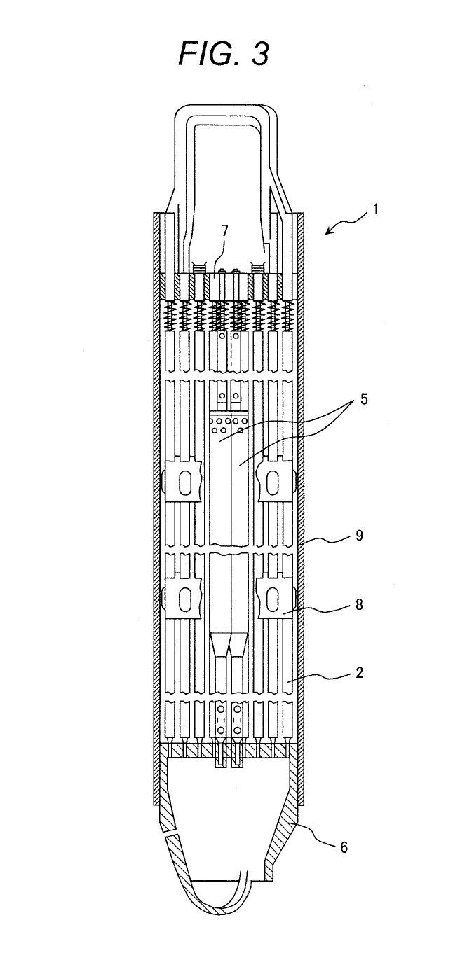

The fuel assembly 1 according to the present embodiment is provided with a plurality of fuel rods 2, two water rods 5, a lower tie plate 6, an upper tie plate 7, a plurality of fuel spacers 8, and a channel box 9 as shown in FIG. 3. The fuel rod 2 is filled with a plurality of fuel pellets (not shown) formed with nuclear fuel material filled in a fuel cladding (not shown). A lower end portion of each fuel rod 2 is supported by the lower tie plate 6, and an upper end portion of each fuel rod 2 is supported by the upper tie plate 5. Part of the fuel rods 2 do not have a length from the lower tie plate 6 to the upper tie plate 5; these fuel rods are partial length fuel rods having a shorter active fuel length. The lower end portion of each of the water rods 5 is supported by the lower tie plate 6, and the upper end portion of each of the water rods 5 is held by the upper tie plate 7. The plurality of fuel spacers 8 are disposed at given intervals in the axial direction of the fuel assembly 1 to maintain the space formed among the fuel rods 2 at a given width. Additionally, the space between the water rods 5 and the space between the water rod 5 and adjacent fuel rods 2 are also maintained at a given width by the fuel spacers 8. The fuel rods 2 bundled by the fuel spacers 8 are disposed in the channel box 9. An upper end portion of the channel box 9 is installed to the upper tie plate 7 and the channel box 9 extends downward to the lower tie plate 6.

As shown in FIG. 1, the plurality of fuel rods 2 are arranged in 10 rows and 10 columns in the cross-section of the fuel assembly 1. These fuel rods 2 are disposed in the channel box 9 which is a square tube having a square cross-section. The two water rods 5 are disposed in the center portion of the cross-section of the fuel assembly 1, taking up a region in which eight fuel rods 2 can be disposed.

The fuel pellets to be filled in the fuel rods 2 are manufactured using uranium dioxide, which is a nuclear fuel material, and contain uranium 235, which is a fissile material. The plurality of fuel rods 2 in the fuel assembly 1 include fuel rods 3 (hereinafter referred to as uranium fuel rods) filled with a plurality of pellets containing uranium but not gadolinia as burnable poison, and fuels rods 4 (hereinafter referred to as burnable poison-contained fuel rods) filled with a plurality of pellets containing uranium and gadolinia.

The plurality of fuel rods 2 include fuel rods U1, U2, U3, U4, P1, G1, G2, and G3. The fuel rods U1, U2, U3, U4, and P1 are the uranium fuel rods 3 and the fuel rods G1, G2, and G3 are the burnable poison-contained fuel rods 4. The fuel rods P1 among the uranium fuel rods 3 are partial length fuel rods. The fuel assembly 1 has 92 fuel rods 2. Within the fuel rods 2, 78 fuel rods are the uranium fuel rods 3, and 14 of the 78 are the partial length fuel rods. The remaining 14 are the burnable poison-contained fuel rods 4. The burnable poison-contained fuel rods 4 are dispersedly disposed without being adjacent to each other to prevent a decrease in neutron absorbing effect. The fuel rods P1, which are the partial length fuel rods, are disposed for the purpose of increasing an area of passage for coolant in the channel box 9 to reduce pressure drop in the fuel assembly 1 and to have a proper water-to-uranium volume ratio.

The fuel rods P1, which are the partial length fuel rods, are disposed in a second layer from the inner surface of the channel box 9 and adjacent to the water rods 5, in an array of fuel rods. The fuel rods G3 are disposed in the second layer from the inner surface of the channel box 9, and the fuel rods G1 and G2 are disposed inside the second layer.

The distribution of enrichments of the fuel rods U1, U2, U3, U4, P1, G1, G2, and G3 and the distribution of concentrations of gadolinia in the fuel rods G1, G2, and G3 in the fuel assembly 1 with a burnup of 0 GWd/t will be described in detail with reference to FIG. 2. Fuel rod numbers, U1, U2, U3, U4, P1, G1, G2, and G3 shown in FIG. 2, correspond to the fuel rod numbers shown in FIG. 1. In FIG. 2, the numbers shown without parenthesis in each fuel rod are uranium enrichments, and the numbers shown in parenthesis are gadolinia concentrations. Each of the numbers shown in the far right of the FIG. 2 is the length of in an axial direction of each zone in each fuel rod 2 when the total axial length of the active fuel length of the fuel assembly 1 is 24. Hereinafter, the length of in an axial direction of each zone in the fuel rods U1, U2, U3, U4, P1, G1, G2, and G3 is always expressed in this unit.

The fuel rods U1, U2, U3, U4, P1, G1, G2, and G3 each have a natural uranium blanket zone (hereinafter referred to as an NU zone) in a lower end portion of the active fuel length. The fuel rods U1, U2, U3, U4, G1, G2, and G3 each have the NU zone in an upper end portion of the active fuel length. A zone between the NU zones in the lower end and the upper end portions is an enriched uranium zone. The fuel rods G1, G2, and G3 each contain gadolinia in part of their enriched uranium zone.

The enriched uranium zone in each of the fuel rods U4, P1, G1, G2, and G3 has a uranium enrichment of 4.9 wt %. The enriched uranium zone in the fuel rod U1 has a uranium enrichment of 2.8 wt %, the enriched uranium zone in the fuel rod U2 has a uranium enrichment of 3.9 wt %, and the enriched uranium zone in the fuel rod U3 has a uranium enrichment of 4.4 wt %.

Hereinafter, the total length in the axial direction of the active fuel length is simply referred to as the total axial length. The concentrations of gadolinia in the fuel rod G1 are 2 wt % in between a position up to 1/24 of the total axial length from the lower end of the active fuel length and a position up to 6/24 of the total axial length from the lower end of the active fuel length, 8 wt % in between the position up to 6/24 and a position up to 21/24 of the total axial length from the lower end of the active fuel length, and 4 wt % in between the position up to 21/24 and a position up to 23/24 of the total axial length from the lower end of the active fuel length. The concentrations of gadolinia in the fuel rod G2 are 8 wt % in between the position up to 1/24 and a position up to 2/24 of the total axial length from the lower end of the active fuel length, 5 wt % in between the position up to 2/24 and a position up to 4/24 of the total axial length from the lower end of the active fuel length, 8 wt % in between the position up to 4/24 and a position up to 21/24 of the total axial length from the lower end of the active fuel length, and 4 wt % in between the position up to 21/24 and the level 23/24 of the total axial length from the lower end of the active fuel length. The concentrations of gadolinia in the fuel rod G3 are 10 wt % in between the position up to 1/24 and the position up to 2/24 of the total axial length from the lower end of the active fuel length, 6 wt % in between the position up to 2/24 and the position up to 4/24 of the total axial length from the lower end of the active fuel length, 10 wt % in between the position up to 4/24 and the position up to 21/24 of the total axial length from the lower end of the active fuel length, and 4 wt % in between the position up to 21/24 and the position up to 23/24 of the total axial length from the lower end of the active fuel length.

In the fuel assembly 1, an average enrichment of a lower enriched uranium zone including the fuel rods P1 is approximately 4.7 wt %, and a average enrichment of an upper enriched uranium zones without the fuel rods P1 is approximately 4.6 wt %. The lower enriched uranium zone is a zone between the position up to 1/24 and the position up to 14/24 of the total axial length from the lower end of the active fuel length. The upper enriched uranium zone is a zone between the position up to 14/24 and the position up to 23/24 of the total axial length from the lower end of the active fuel length. The average enrichment of the entire fuel assembly 1 including the NU zones in the lower and the upper portions is approximately 4.3 wt %.

In a core made up by loading the fuel assemblies 1, before the start of one operation cycle of a nuclear core, 160 fuel assemblies 1 of 400 fuel assemblies loaded into the core have a burnup of 0 GWd/t. Thus, the batch number of the core is 2.5.

In the fuel rod G1 in the fuel assembly 1, the plurality of fuel pellets with a gadolinia concentration of 2 wt % and a uranium enrichment of 4.9 wt % are filled in the zone between the position up to 1/24 and the position up to 6/24 of the total axial length from the lower end of the active fuel length, and are a nuclear fuel material C because the gadolinia with a concentration of 2 wt % contained in the fuel pellets burns out in the beginning of the operation cycle. In the fuel rod G2, the plurality of fuel pellets with a gadolinia concentration of 5 wt % and a uranium enrichment of 4.9 wt % are filled in the zone between the position up to 2/24 and the position up to 4/24 of the total axial length from the lower end of the active fuel length, and in the fuel rod G3, the plurality of fuel pellets with a gadolinia concentration of 6 wt % and a uranium enrichment of 4.9 wt % are filled in the zone between the position up to 2/24 and the position up to 4/24 of the total axial length from the lower end of the active fuel length; and since the gadolinia with concentrations of 5 wt % and 6 wt % contained in the respective fuel pellets burns out in the middle of the operation cycle, the pluralities of fuel pellets are nuclear fuel materials B.

In each of the fuel rods G1, G2, and G3, the plurality of fuel pellets with a uranium enrichment of 4.9 wt % filled in the zone between the position up to 21/24 and the position up to 23/24 of the total axial length from the lower end of the active fuel length contain gadolinia with a low concentration, that is, a concentration of 4 wt %. In the zone between the position up to 21/24 and the position up to 23/24 of the total axial length from the lower end of the active fuel length, cooling water flowing among the fuel rods 2 contains a large quantity of void, yielding a high void fraction. Because of this, the gadolinia contained in the fuel pellets in the zone, while having a low concentration of 4 wt %, burns slowly and disappears during the end of the operation cycle.

The core of a boiling water reactor is made up by, for example, loading 400 fuel assemblies 1. The core is disposed in a reactor pressure vessel of the boiling water reactor, and one control rod 10 is disposed for every four fuel assemblies 1 in the core. As a whole, the core has 100 control rods 10. At the start of an operation cycle, the fuel assemblies 1 loaded into the core have different in-core fuel dwelling times. 160 fuel assemblies 1 of the 400 fuel assemblies 1 have a burnup of 0 GWd/t and these fuel assemblies (hereinafter referred to as the first fuel assemblies) 1 will experience the first operation cycle from now. These first fuel assemblies 1 with a burnup of 0 GWd/t include the fuel rods U1, U2, U3, U4, P1, G1, G2, and G3 having the distribution of enrichments and the distribution of gadolinia concentrations shown in FIG. 2. The other 160 fuel assemblies 1 out of the 400 have experienced the previous operation cycle and these fuel assemblies (hereinafter referred to as the second fuel assemblies) will experience the second operation cycle after this. The remaining 80 fuel assemblies 1 have experienced the second previous operation cycles and these fuel assemblies (hereinafter referred to the third fuel assemblies) will experience the third operation cycle after this. Each fuel rod disposed in the second and the third fuel assemblies 1 had the distribution of enrichments and the distribution of gadolinia concentrations shown in FIG. 2 when it was loaded into the core at a burnup of 0 GWd/t.

The 80 third fuel assemblies 1 are disposed in the outer circumferential portion in the core. The 160 first and the 160 second fuel assemblies 1 are mixedly disposed inside the outer circumferential portion in the core. The third fuel assemblies 1 are disposed so as to surround the region in the core disposed with the first and the second fuel assemblies 1.

A lower end portion of each fuel assembly 1 loaded into the core is supported by a fuel supporting fastener provided to a core plate installed in the reactor pressure vessel. An upper end portion of each fuel assembly 1 is supported by an upper grid plate installed in the reactor pressure vessel.

The control rod 10 is inserted among the four fuel assemblies 1. The upper portion of the channel box 9 is attached to the upper tie plate 7 by a single channel fastener (not shown). The channel fastener has a function of keeping the space among the fuel assemblies 1 at an appropriate width so that the control rod 10 can be surely inserted into the space among the fuel assemblies 1 loaded into the core. Thus, the channel fastener is disposed at a corner portion of the fuel assembly 1 facing the side surface of the channel box 9, and joined with the upper tie plate 7.

After one operation cycle is completed and the boiling water reactor is shut down, an upper cover installed to the upper end portion of the reactor pressure vessel is removed and then a fuel exchange operation is performed. In this fuel exchange operation, 80 third fuel assemblies 1 in the core and 80 second fuel assemblies 1 out of the 160 second fuel assemblies 1 are taken out from the core and moved outside the reactor pressure vessel. The remaining 80 second fuel assemblies are moved and disposed in the outer circumferential portion described above in the core. In place of the 160 fuel assemblies 1 taken out from the core, 160 fuel assemblies 1 with a burnup of 0 GWd/t are loaded inside the outer circumferential portion in the core.

After the fuel exchange operation, the upper cover is installed to the reactor pressure vessel to seal the reactor pressure vessel. Then, the next operation cycle of the boiling water reactor is started.

The batch number n of the above core is 2.5. In the fuel assembly 1 with a burnup of 0 GWd/t having the above structure, the concentration aₘₐₓ of burnable poison is 10 wt % and the average enrichment e of the nuclear fuel material is 4.3 wt %. Thus, aₘₐₓn/e is 5.8 and the fuel assembly 1 satisfies the condition of 4.0<aₘₐₓn/e<7.0.

In the fuel assembly 1, the number of all the fuel rods is 92 and the number of the burnable poison-contained fuel rods 4 (the fuel rods G1, G2, and G3) is 14, thus the ratio of the number of the burnable poison-contained fuel rods 4 to the number of all the fuel rods is 15%.

Since the concentration c of gadolinia contained in the nuclear fuel material C is 2 wt %, c/aₘₐₓ in the fuel assembly 1 is 0.2. Therefore, the concentration c of the gadolinia contained in the nuclear fuel material C satisfies 0.0<c/aₘₐₓ≦0.4. Since the concentrations b of gadolinia contained in the nuclear fuel materials B are 5 wt % and 6 wt %, b/aₘₐₓ in the fuel assembly 1 are 0.5 and 0.6 respectively. Therefore, the concentrations b of the gadolinia contained in the nuclear fuel materials B satisfy 0.4<b/aₘₐₓ≦0.7. Since the concentrations a of the gadolinia contained in the nuclear fuel materials A are 8 wt % and 10 wt %, a/aₘₐₓ in the fuel assembly 1 are 0.8 and 1 respectively. Therefore, the concentrations a of the gadolinia contained in the nuclear fuel materials A satisfy 0.7<a/aₘₐₓ≦1.0.

In the fuel assembly 1, the nuclear fuel material C containing 2 wt % gadolinia is disposed in the fuel rod G1 between the position up to 1/24 and the position up to 6/24 of the total axial length from the lower end of the active fuel length, and the nuclear fuel materials B containing 5 wt % and 6 wt % gadolinia are disposed in the fuel rods G2 and G3 respectively between the position up to 2/24 and the position up to 4/24 of the total axial length from the lower end of the active fuel length. In this way, the nuclear fuel materials B and C are disposed between the position up to 1/24 and the position up to 19/24 of the total axial length from the lower end of the active fuel length in the present embodiment.

The length of 1/24 of the total axial length of the active fuel length is 1 node. The nuclear fuel material C is filled in 1 fuel rod G1 only, and the zone filled with the nuclear fuel material C has 5 nodes (total length L(C)). The nuclear fuel material B is filled in 5 fuel rods G2 and 8 fuel rods G3. Since the zones filled with the nuclear material B in the fuels rods G2 and G3 have both 2 nodes per fuel rod, the total node of the zones filled with the nuclear fuel material B in the 5 fuel rods G2 and the 8 fuel rods G3 is 26 nodes (total length L(B)). The nuclear fuel material A is contained in 1 fuel rod G1, 5 fuel rods G2, and 8 fuel rods G3. The number of nodes that the nuclear fuel material A has in the single fuel rod G1 is 15, and the numbers of nodes that the nuclear fuel material A has in the fuel rods G2 and G3 are each 18 per fuel rod. The total node of the zones filled with the nuclear fuel material A in the single fuel rod G1, the 5 fuel rods G2, and the 8 fuel rods G3 is 249 nodes (total length L(A)). Since L(A)/5.0 is 49.8 in the fuel assembly 1, the fuel assembly 1 satisfies L(A)/5.0 L(B). Furthermore, since L(B)/5.0 is 5.2, the fuel assembly 1 satisfies L(B)/5.0 L(C).

In the fuel assembly 1 according to the present embodiment, the concentrations a of the gadolinia contained in the nuclear fuel materials A satisfy 0.7<a/aₘₐₓ≦1.0, the concentrations b of the gadolinia contained in the nuclear fuel materials B satisfy 0.4<b/aₘₐₓ≦0.7, and L(A)/5.0≧L(B) is satisfied. Thus, according to the present embodiment, a downwardly convex change in the first reactivity during the middle of the 1st operation cycle, which is first operation cycle for the fuel assembly 1 with a burnup of 0 GWd/t, caused by the nuclear fuel materials A containing gadolinia with concentrations a (8 wt % and 10 wt %), can be compensated by the effect of gadolinia with concentrations b (5 wt % and 6 wt %) contained in the nuclear fuel materials B which burn out during the middle of the operation cycle. The downwardly convex change in the first reactivity during the middle of the operation cycle can be improved, and the variation range of the excess reactivity of the core in the operation cycle can be reduced.

The present embodiment can improve the downwardly convex change in the first reactivity during the middle of the operation cycle, which cannot be improved in the fuel assembly shown in FIGS. 1 and 2 of Japanese Patent Laid-open No. 3 (1991)-267793 and the fuel assembly shown in FIGS. 15 and 16 of Japanese Patent Laid-open No. 2 (1990)-245693, by using the effect of gadolinia with concentrations b (5 wt % and 6 wt %) contained in the nuclear fuel materials B. Thus, the variation range of excess reactivity in the operation cycle can be reduced.

Additionally, in the fuel assembly 1, the concentration c of the gadolinia contained in the nuclear fuel material C satisfies 0.0<c/aₘₐₓ≦0.4, and L(B)/5.0>L(C) is satisfied. Thus, according to the present embodiment, a downwardly convex change in the second reactivity during the beginning of the first operation cycle for the fuel assembly 1 with a burnup of 0 GWd/t, caused by the nuclear fuel materials B containing gadolinia with concentrations b (5 wt % and 6 wt %), can be compensated by the effect of the gadolinia with a concentration c (2 wt %) contained in the nuclear fuel material C which burns out during the beginning of the operation cycle. Thus, the downwardly convex change in the second reactivity during the beginning of the operation cycle can be improved.

As a result, the variation range of excess reactivity in the operation cycle which was improved by the effect of the gadolinia with concentrations b (5 wt % and 6 wt %) contained in the nuclear fuel materials B can be further improved by the effect of the gadolinia with a concentration c (2 wt %) contained in the nuclear fuel material C. Due to the effect of the gadolinia with concentrations b (5 wt % and 6 wt %) contained in the nuclear fuel materials B and the gadolinia with a concentration c (2 wt %) contained in the nuclear fuel material C, the variation range of excess reactivity in the operation cycle can be reduced as shown in FIG. 15, and the variation range can be more flattened throughout the operation cycle.

According to the present embodiment, the nuclear fuel materials B and C are disposed between the position up to 1/24 and the position up to 19/24 of the total axial length from the lower end of the active fuel length, which is between the position up to 1/24 and the position up to 19/24 of the total axial length from the lower end of the active fuel length, so that the gadolinia contained in the nuclear fuel material C burns out by the completion of the beginning of the operation cycle and the gadolinia contained in the nuclear fuel material B burns out by the completion of the middle of the operation cycle. In this way, the gadolinia contained in the nuclear fuel materials C and B burns out, respectively, thus the above effect can be obtained.

The nuclear fuel materials A, B, and C may be filled in the same burnable poison-contained fuel rod 4.

### Embodiment 2

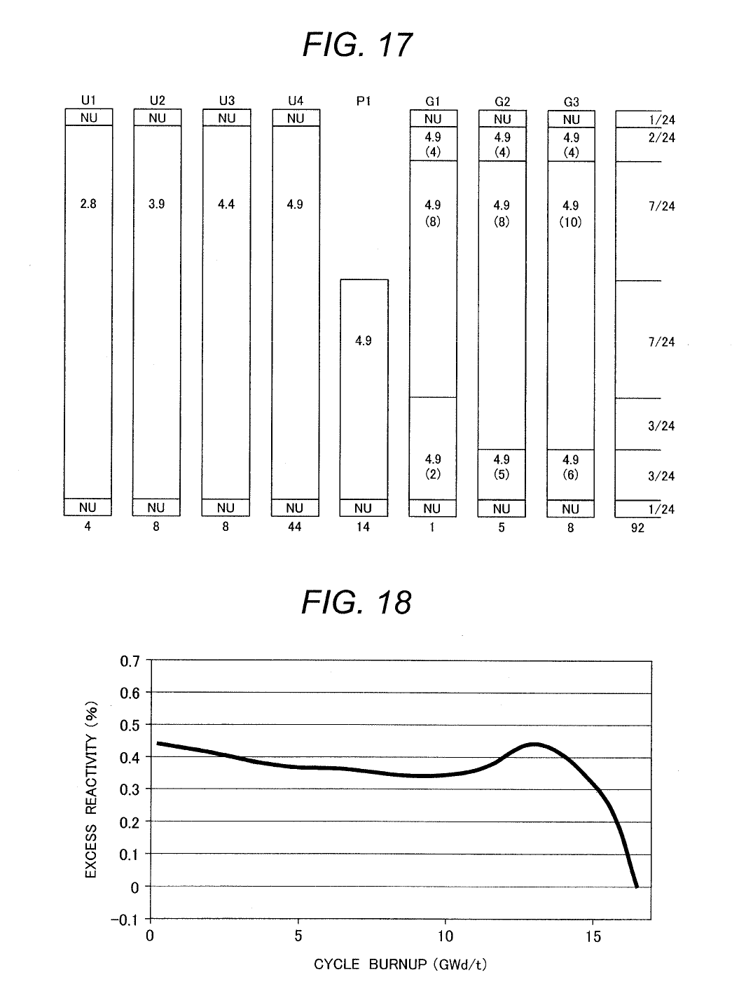

A fuel assembly according to embodiment 2, which is another preferred embodiment of the present invention, will be described with reference to FIGS. 1 and 17. The fuel assembly according to the present embodiment (called fuel assembly 1A for convenience in writing to distinguish from the fuel assembly 1 according to embodiment 1) is for loading into the core of a boiling water reactor.

The fuel assembly 1A in the present embodiment is different from the fuel assembly 1 in embodiment 1 only in the distribution of gadolinia concentrations in the fuel rods G1, G2, and G3. The fuel rod G1 of the fuel assembly 1A, as shown in FIG. 17, is filled with the nuclear fuel material C containing 2 wt % gadolinia in a zone between the position up to 1/24 and a position up to 7/24 of the total axial length from the lower end of the active fuel length and the nuclear fuel material A containing 8 wt % gadolinia in a zone between the position up to 7/24 and the position up to 21/24 of the total axial length from the lower end of the active fuel length. The fuel rod G2 of the fuel assembly 1A is filled with the nuclear fuel material B containing 5 wt % gadolinia in a zone between the position up to 1/24 and the position up to 4/24 of the total axial length from the lower end of the active fuel length and the nuclear fuel material A containing 8 wt % gadolinia in a zone between the position up to 4/24 and the position up to 21/24 of the total axial length from the lower end of the active fuel length. The fuel rod G3 of the fuel assembly 1A is filled with the nuclear fuel material B containing 6 wt % gadolinia in a zone between the position up to 1/24 and the position up to 4/24 of the total axial length from the lower end of the active fuel length and the nuclear fuel material A containing 10 wt % gadolinia in a zone between the position up to 4/24 and the position up to 21/24 of the total axial length from the lower end of the active fuel length. Furthermore, the fuel rods G1, G2, and G3 are each filled with the nuclear fuel material containing 4 wt % gadolinia in a zone between the position up to 21/24 and the position up to 23/24 of the total axial length from the lower end of the active fuel length. The other structure including the distribution of uranium enrichments in the fuel assembly 1A is the same as the fuel assembly 1. The arrangement of the fuel rods U1, U2, U3, U4, P1, G1, G2, and G3 in a cross-section of the fuel assembly 1A is the same as the arrangement of those fuel rods in the cross-section of the fuel assembly 1 shown in FIG. 1.

In the same manner as the core of the boiling water reactor described in embodiment 1, a core is made up using the fuel assemblies 1A in the present embodiment. The batch number n of this core is also 2.5. In the fuel assembly 1A with a burnup of 0 GWd/t having the above structure, the concentration aₘₐₓ of burnable poison is 10 wt % and the average enrichment e of the nuclear fuel material is 4.3 wt %. Thus, aₘₐₓn/e is 5.8 and the fuel assembly 1A satisfies the condition of 4.0<aₘₐₓn/e<7.0.

In the fuel assembly 1A, the number of total fuel rods is 92, the number of the burnable poison-contained fuel rods 4 (the fuel rods G1, G2, and G3) is 14, thus the ratio of the number of the burnable poison-contained fuel rods 4 to the number of all the fuel rods is 15%.

In the fuel assembly 1A according to the present embodiment, the total length L (A) is 235 nodes, the total length L(B) is 39 nodes, and the total length L(C) is 6 nodes.

Thus, in the fuel assembly 1A, in the same manner as the fuel assembly 1, the concentrations a of the gadolinia contained in the nuclear fuel materials A (8 wt % and 10 wt %) satisfy 0.7<a/aₘₐₓ≦1.0, the concentrations b of the gadolinia contained in the nuclear fuel materials B (5 wt % and 6 wt %) satisfy 0.4<b/aₘₐₓ≦0.7, and L(A)/5.0≧L(B) is satisfied. The fuel assembly 1A, in the same manner as the fuel assembly 1, can improve a downwardly convex change in the first reactivity during the middle of the operation cycle and can reduce the variation range of the excess reactivity of the core in the operation cycle.

In the fuel assembly 1A, the concentration c of the gadolinia contained in the nuclear fuel material C (2 wt %) satisfies 0.0<c/aₘₐₓ≦0.4, and L(B)/5.0>L(C) is satisfied. The variation range of the excess reactivity of the core made up of such fuel assemblies 1A during the operation cycle is further reduced than the variation range of the excess reactivity of the core made up of the fuel assemblies 1 according to embodiment 1, during the operation cycle.

In the present embodiment, all the nuclear fuel materials B are disposed below the nuclear fuel materials A in the axial direction of the fuel assembly 1A. In this structure, the nuclear fuel materials B in the fuel assembly 1A can be disposed lower compared to the nuclear fuel materials B in the fuel assembly 1. For this reason, the power distribution in an axial direction of the fuel assembly 1A has a lower peak than embodiment 1 during the middle of the operation cycle when the gadolinia contained in the nuclear fuel materials B burns out and the reactivity is increased. Then, the average void fraction of the core is increased, the neutron spectrum is hardened, and plutonium can be accumulated. Furthermore, during the end of the operation cycle, the power distribution in the axial direction of the core shows an upper peak because the burnable poison in the upper zone of the fuel assembly 1A burns out and the burning of the nuclear fuel material in the lower zone of the fuel assembly 1A proceeds since before the end of the operation cycle. Because of this, the average void fraction of the core is reduced, the neutron spectrum is softened, and the burning of the accumulated plutonium is promoted; thus, the reactivity is increased during the end of the operation cycle. As a result, the reactivity during the end of the operation cycle increases, a decrease in the excess reactivity during the end of cycle can be held down, and the variation range of the excess reactivity can be reduced.

As shown in FIG. 18, the variation range of the excess reactivity of the core made up of the fuel assemblies 1A is 0.44%, which is further reduced than the variation range (0.50%) of excess reactivity in embodiment 1.

Each embodiment in embodiments 1 and 2 described above can be applied not only to the fuel assembly having a fuel rod array of 10 rows by 10 columns but also to a fuel assembly having a different fuel rod array such as 8 rows by 8 columns or 9 rows by 9 columns.

Each embodiment in embodiments 1 and 2 described above can be applied to a fuel assembly which does not include a partial length fuel rod.

Furthermore, each embodiment in embodiments 1 and 2 described above can be applied to a fuel assembly having one water rod and a fuel assembly having a square cross-section water rod. Each embodiment in embodiments 1 and 2 described above can be applied to a fuel assembly having not only the nuclear fuel material containing uranium but also the nuclear fuel material containing plutonium when the burnup is 0 GWd/t.

### REFERENCE SIGNS LIST

1, 1A: fuel assembly, 2: fuel rod, 3: uranium fuel rod, 4: burnable poison-contained fuel rod, 5: water rod, 6: lower tie plate, 7: upper tie plate, 8: fuel spacer, 9: channel box, 10: control rod.

What is claimed is:

1. A fuel assembly comprising:
a plurality of fuel rods; an upper tie plate for supporting an upper end portion of each of the fuel rods; a lower tie plate for supporting a lower end portion of each of the fuel rods; a plurality of fuel spacers for maintaining space among the fuel rods; and a channel box for surrounding the plurality of fuel rods bundled by the fuel spacers,
wherein the plurality of fuel rods include a plurality of first fuel rods filled with nuclear fuel material not containing burnable poison and a plurality of second fuel rods filled with nuclear fuel material containing the burnable poison;
wherein the number of the second fuel rods is at least 8% of the total number of the first and the second fuel rods;
wherein when a highest concentration among concentrations of the burnable poison contained in the nuclear fuel material filled in the plurality of second fuel rods is aₘₐₓ; a concentration a of the burnable poison contained in the nuclear fuel material is in a range of 0.7<a/aₘₐₓ≦1.0; a concentration b of the burnable poison contained in the nuclear fuel material is in a range of 0.4<b/aₘₐₓ≦0.7; and a concentration c of the burnable poison contained in the nuclear fuel material is in a range of 0<c/aₘₐₓ≦0.4, a nuclear fuel material B, which is the nuclear fuel material containing the burnable poison with the concentration b, and a nuclear fuel material C, which is the nuclear fuel material containing the burnable poison with the concentration c, are disposed between a position up to 1/24 of a total length in an axial direction of an active fuel length from a lower end of the active fuel length of the fuel assembly and a position up to 19/24 of the total length in the axial direction of the active fuel length from the lower end of the active fuel length, and
a total length L(A) in the axial direction of zones filled with nuclear fuel materials A, which are the nuclear fuel materials containing the burnable poison with the concentration a, in all the second fuel rods, a total length L(B) in the axial direction of zones filled with the nuclear fuel materials B in all the second fuel rods, and a total length L(C) in the axial direction of zones filled with the nuclear fuel materials C in all the second fuel rods satisfy L(A)/5.0≧L(B) and L(B)/5.0≧L(C).

2. The fuel assembly according to claim 1, wherein when an average enrichment of the nuclear fuel materials in the fuel assembly is e, and a ratio of the number of the fuel assemblies to be changed in one fuel exchange in a core made up of loading the fuel assemblies to the number of all the fuel assemblies in the core is n, the concentration aₘₐₓ of the burnable poison satisfies 4.0<aₘₐₓn/e<7.0.

3. The fuel assembly according to claim 1, wherein all the nuclear fuel materials B are disposed lower than the nuclear fuel materials A.

4. The fuel assembly according to claim 2, wherein all the nuclear fuel materials B are disposed lower than the nuclear fuel materials A.

5. A core of a nuclear reactor comprising:
a plurality of fuel assemblies provided with a plurality of fuel rods, an upper tie plate for supporting an upper end portion of each of the fuel rods, a lower tie plate for supporting a lower end portion of each of the fuel rods, a plurality of fuel spacers for maintaining space among the fuel rods, and a channel box for surrounding the plurality of fuel rods bundled by the fuel spacers, the plurality of fuel rods including a plurality of first fuel rods filled with a nuclear fuel material not containing burnable poison and a plurality of second fuel rods filled with the nuclear fuel material containing the burnable poison,
wherein a plurality of the fuel assemblies with a burnup of 0 GWd/t which is part of the plurality of fuel assemblies have the second fuel rods, the number of which is at least 8% of the total number of the first and the second fuel rods;
wherein in the plurality of the fuel assemblies with a burnup of 0 GWd/t, when a highest concentration among concentrations of the burnable poison contained in the nuclear fuel material filled in the plurality of second fuel rods is aₘₐₓ; a concentration a of the burnable poison contained in the nuclear fuel material is in a range of 0.7<a/aₘₐₓ≦1.0, a concentration b of the burnable poison contained in the nuclear fuel material is in a range of 0.4<b/aₘₐₓ<0.7; and a concentration c of the burnable poison contained in the nuclear fuel material is in a range of 0<c/aₘₐₓ<0.4, a nuclear fuel material B, which is the nuclear fuel material containing the burnable poison with the concentration b, and a nuclear fuel material C, which is the nuclear fuel material containing the burnable poison with the concentration c, are disposed between a position up to 1/24 a total axial length in an axial direction of an active fuel length of the fuel assembly from a lower end of the active fuel length and a position up to 19/24 of the total length in the axial direction of the active fuel length from the lower end of the active fuel length; and
wherein in the plurality of the fuel assemblies with a burnup of 0 GWd/t, when a total length in the axial direction of zones filled with nuclear fuel materials A, which are the nuclear fuel materials containing the burnable poison with the concentration a, in all the second fuel rods is L(A), a total length in the axial direction of zones filled with the nuclear fuel materials B in all the second fuel rods is L(B), and a total length in the axial direction of zones filled with the nuclear fuel materials C in all the second fuel rods is L(C), L(A)/5.0≧L(B) and L(B)/5.0≧L(C) are satisfied.

6. The nuclear core according to claim 5, wherein when an average enrichment of the nuclear fuel materials in the fuel assembly is e, and a ratio of the number of the fuel assemblies to be changed in one fuel exchange in a core made up of loading the fuel assemblies to the number of all the fuel assemblies in the core is n, the concentration aₘₐₓ of the burnable poison satisfies 4.0<aₘₐₓn/e<7.0.

7. The nuclear core according to claim 5, wherein all the nuclear fuel materials B are disposed lower than the nuclear fuel materials A.

8. The nuclear core according to claim 6, wherein all the nuclear fuel materials B are disposed lower than the nuclear fuel materials A.
